(19) United States
(12) Patent Application Publication
(10) Pub. No.: US 2026/0315982 A1
(43) Pub. Date: Oct. 15, 2026

(54) HOLDING TANK FILTER SYSTEM

(71) Applicant: PHINIA Jersey Holdings LLC, Wilmington, DE (US)

(72) Inventors: Maria Rocio Lemaster, Ortonville, MI (US); Thomas Rodrigues Martin, Troy, MI (US); Richard Hoag, Caledonia, NY (US); Mario Alfonso Cruz Nunez, Oxford, MI (US)

(21) Appl. No.: 19/483,057

(22) PCT Filed: May 7, 2024
(86) PCT No.: PCT/US2024/028127

§ 371 Date: Nov. 10, 2025

Related U.S. Application Data
(60) Provisional application No. 63/465,367, filed on May 10, 2023.

(51) Int. Cl. B01D 46/88; B01D 46/24; B01D 46/42

(52) U.S. Cl. CPC B01D 46/88; B01D 46/2411; B01D 46/4272; B01D 2265/026; B01D 2265/029; B01D 2271/027

(57) ABSTRACT

A filter system for a gas discharge line is provided. The filter system comprises a filter cartridge, a valve hub, and a discharge connector. The valve hub defines an interior cavity. The valve hub has a first hub end shaped for connection with a first portion of the gas discharge line and a second hub end shaped to releasably couple to the first end of the filter cartridge. A valve is movably disposed in the interior cavity, the valve is moveable between a closed position when the filter cartridge is uncoupled from the valve hub and an open position when the filter cartridge is coupled to the valve hub. The discharge connector has a first connector end shaped to releasably couple to the second end of the filter cartridge and a second connector end shaped for connection with a second portion of the gas discharge line.

### FIELD OF THE INVENTION

The disclosure generally relates to a holding tank filter, more specifically, to a holding tank vent filter that can be connected to a holding tank to filter gas as it is discharged from the holding tank to eliminate odor associated with the content, e.g., sewage, contained in the holding tank.

### BACKGROUND OF THE INVENTION

Various vehicles, campers, and marine vessels have holding tanks that collect and store sewage including wastewater and human excreta. Holding tanks are vented to ensure that as sewage enters and collects, the air in the holding tank has someplace to go (other than back into the vehicle, camper, or marine vessel). Venting can also accommodate off gassing from the sewage collected in the holding tank as well as gas produced via the vaporization of the liquids within the holding tank.

Venting is accomplished with a gas discharge line, e.g., a pipe or a tube. One end of the gas discharge line is connected to the holding tank while the other end of the gas discharge line extends to a vent on the exterior of the vehicle, camper, or marine vessel. Although venting eliminates issues associated with the interior discharge of gas and foul odors, venting does not eliminate issues associated with discharge of gas and foul odors to the exterior of vehicles, campers, or marine vessels, especially when stationary. In such situations, gas is released from the vent exposing individuals in the immediate vicinity, e.g., at the campground, on the dock, etc. to foul odors and potentially unsanitary conditions.

To resolve issues associated with the discharge of gas and elimination of foul odors therefrom, filters are added to gas discharge lines to remove foul odors and discharge innocuous gas. However, filter media loses effectiveness over time. As such, the foul odor problems highlighted above resurface. Accordingly, filters are replaced to eliminate the foul odors, which are no longer being removed by the filter. However, replacing a filter in a gas discharge line can be stinky, tedious work.

### BRIEF SUMMARY

A filter system for coupling a filter cartridge to a gas discharge line of a holding tank is provided. The filter system comprises a filter cartridge, a valve hub, and a discharge connector. The filter cartridge has a first end and a second end and defines a chamber. The valve hub has a valve hub body that defines an exterior and an interior surface. The interior surface defines an interior cavity, which is disposed about a longitudinal axis. The valve hub has a first hub end shaped for connection with a first portion of the gas discharge line and a second hub end shaped to releasably couple to the first end of the filter cartridge. A valve is movably disposed in the interior cavity, the valve is moveable between a closed position when the filter cartridge is uncoupled from the valve hub and an open position when the filter cartridge is coupled to the valve hub. The discharge connector has a connector body that defines an exterior connector surface and an interior connector surface. The discharge connector has a first connector end shaped to releasably couple to the second end of the filter cartridge and a second connector end shaped for connection with a second portion of the gas discharge line. When the first hub end of the valve hub is connected with a first portion of the gas discharge line, the first end of the filter cartridge is releasably coupled to the second hub end of the valve hub, the second end of the filter cartridge is releasably coupled with the first connector end of the discharge connector, and the second connector end of the discharge connector is connected with the second portion of the gas discharge line the system allows for filtering and discharge of gas from the holding tank because the valve of the valve hub is in an open position. When the filter cartridge is uncoupled from the valve hub, the valve moves from the open position to the closed position to prevent discharge of unfiltered gas from the holding tank so that the filter cartridge can be replaced without the emanation of odor from the holding tank.

A method of replacing the filter cartridge with a replacement filter cartridge is also disclosed. The first end of the filter cartridge is decoupled from the valve hub thereby preventing discharge of unfiltered gas from the holding tank during replacement of the filter cartridge with the replacement filter cartridge. The second end of the filter cartridge is then decoupled from the discharge connector. Next, the second end of the replacement filter cartridge is coupled to the discharge connector. In turn, the first end of the replacement filter cartridge is coupled to the valve hub thereby allowing discharge and filtering of gas from the holding tank. During the step of decoupling the first end of the filter cartridge from the valve hub, the valve within the valve hub moves from the open position, which allows the discharge and filtering of gas from the holding tank, to the closed position, which prevents the discharge of gas from the holding tank.

A replacement filter cartridge for a filter system for a gas discharge line for a holding tank is also disclosed. The filter system comprises a valve hub, a filter cartridge, and a discharge connector. The valve hub has a locking element and defines a contact surface and an interior cavity with a valve that is movably disposed therein. The replacement filter cartridge comprises a filter body defining a filter surface and a chamber surface, the chamber surface defines a chamber for holding a filtration media. The filter body has a first end shaped to releasably couple to the valve hub. The first end includes an end probe shaped and positioned to contact the contact surface of the valve in the valve hub and move the valve from a closed position, which prevents discharge of gas from the holding tank, to an open position, which allows discharge and filtering of gas from the holding tank. The replacement filter cartridge comprises a sealing element for providing a pneumatic seal between an interior surface of the valve hub and an outer surface of the first end. The replacement filter cartridge also comprises at least one coupling element shaped to engage the locking element of the valve hub to releasably couple the replacement filter cartridge to the valve hub and maintain contact between the end probe and the contact surface of the valve to maintain the open position and allow discharge and filtering of gas from the holding tank when the replacement filter cartridge is coupled to the valve hub. The filter body has a second end shaped to releasably couple the filter cartridge to the discharge connector.

A quick coupling for a filter cartridge for a gas discharge line of a holding tank is also disclosed. The filter cartridge has a first and a second end. The quick coupling comprises a valve hub having a valve hub body. The valve hub body has an exterior and an interior surface. The interior surface defines an interior cavity disposed about a longitudinal axis. The valve hub has a first hub end shaped for connection with the gas discharge line. The second hub end comprises a locking element shaped to engage a coupling element on a first end of the filter cartridge. A valve is movably disposed in the interior cavity. The valve is moveable between a closed position when the valve hub is uncoupled from the filter cartridge and an open position when the valve hub is coupled to the filter cartridge. When the first end of the filter cartridge is received in the interior cavity at the second hub end and the filter cartridge is coupled to the valve hub, the valve is in the open position to allow for discharge and filtering of gas from the holding tank. When the filter cartridge is removed from the interior cavity at the second hub end and uncoupled from the valve hub the valve moves to the closed position to prevent discharge of unfiltered gas from the holding tank while the filter cartridge is replaced.

### DESCRIPTION OF THE DRAWINGS

Various advantages and aspects of this disclosure may be understood in view of the following detailed description when considered in connection with the accompanying drawings, wherein:

FIG. 1 is a schematic overview of a filter system for a gas discharge line of a holding tank in accordance with embodiments of the disclosure;

FIG. 2 is an isolated view of the valve hub of the filter system of FIG. 1;

FIG. 3 is an isolated view of the filter cartridge of the filter system of FIG. 1;

FIG. 4 is an isolated view of the filter cartridge of the discharge connector of FIG. 1;

FIG. 5 is a side view of the valve hub coupled to the first end of the filter cartridge and the discharge connector connected to the second end of the filter cartridge;

FIG. 6 is a cross-sectional view of FIG. 5 along the longitudinal axis A_{L};

FIG. 7 is a cross-sectional view of FIG. 5 illustrating the flow of gas within the gas discharge line with the valve in the open position;

FIG. 8 is a cross-sectional view of the system of FIG. 5 with the filter cartridge decoupled from the valve hub with the valve in the closed position to prevent discharge and filtering of gas from the holding tank;

FIG. 9 is an exploded side view of the valve hub including a valve hub body and a valve;

FIG. 10 is an isolated, perspective view of the valve hub body;

FIG. 11 is an isolated, perspective view of the valve;

FIG. 12 is a side view of the valve hub;

FIG. 13 is a cross-sectional view of the valve hub of FIG. 12 along the longitudinal axis;

FIG. 14 is an exploded view of the valve hub of FIG. 12 including the valve hub body, the valve, a sealing element, and a biasing element;

FIG. 15 is a cross-sectional view of the valve hub of FIG. 12 with the valve in the closed position;

FIG. 16 is a cross-sectional view of the valve hub 14 of FIG. 12 with the valve 48 in the open position;

FIG. 17 is a perspective view of the valve hub having an engagement halo including a locking element (a pair of locking tabs) and pair of pressure pads;

FIG. 18 is a perspective view of the first end of a filter cartridge including a coupling element (a pair of coupling tabs) that is configured to engage the locking element of the valve hub of FIG. 17;

FIG. 19 is a top view of the valve hub of FIG. 17 illustrating the application of pressure on the pair of pressure pads of the engagement halo;

FIG. 20 is a top view of the engagement halo of FIG. 19 illustrating the elongation of the engagement halo due to the application of pressure on the pair of pressure pads, which moves the coupling element (two coupling tabs) to allow for engagement and disengagement of the locking element of the valve hub and the coupling element of the filter assembly;

FIG. 21 is a perspective view of the discharge connector;

FIG. 22 is a perspective view of a first embodiment of a fitting;

FIG. 23 is a perspective view of a second embodiment of a fitting; and

FIG. 24 is a flow chart documenting a method of replacing the filter cartridge in the filter system 10 for a gas discharge line of a holding tank in accordance with embodiments of the disclosure.

### DETAILED DESCRIPTION OF THE INVENTION

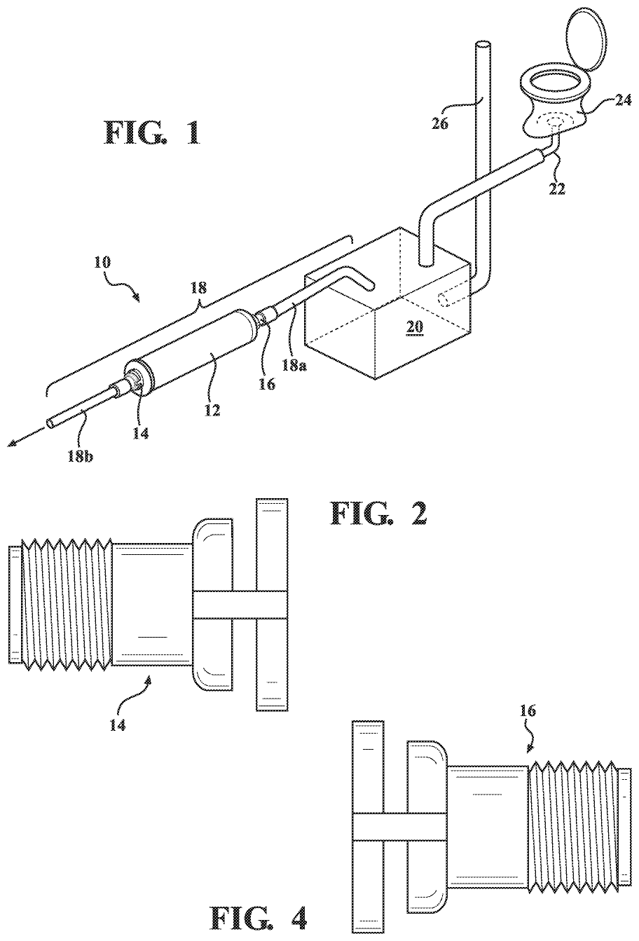

A filter system for a gas discharge line of a holding tank is provided. Referring to FIGS. 1-24, wherein like numerals indicate corresponding parts throughout the several views, a filter system is illustrated and generally designated at 10. The filter system 10 comprises a filter cartridge 12, a valve hub 14, and a discharge connector 16. The filter system 10 provided allows quick coupling of the filter cartridge 12 to a gas discharge line 18 of a holding tank 20 and also allows quick decoupling and replacement of the filter cartridge 12 to the gas discharge line 18 of the holding tank 20. While the filter system is illustrated as for a holding tank of a vehicle, recreational vehicle, camper, or marine vessel, it should be understood that the invention is not limited to holding tank 20 for such applications, but could also be applied to other venting and scrubbing systems for gasses, and in applications other than for vehicles, recreational vehicles, campers, or marine vessels.

FIG. 1 provides an exemplary overview of the filter system 10. The filter system 10 provided allows quick coupling of the filter cartridge 12 to a gas discharge line 18 of a holding tank 20. The holding tank 20 collects and stores sewage including waste and human excreta. In the example illustrated, the holding tank 20 receives waste through an inlet line 22 from a toilet 24, the holding tank 20 can be emptied and cleaned through a pump out line 26. The holding tank 20 is vented to ensure that as sewage enters and collects, the air in the holding tank 20 has someplace to go (other than back into the vehicle, camper, or marine vessel). The filter cartridge 12 filters the gas discharged from the holding tank 20 to reduce foul odors and ensure the release of innocuous, odor-free gas. The filter system 10 allows quick decoupling and replacement of the filter cartridge 12 to the gas discharge line 18 of the holding tank 20. Further, the filter cartridge 12 can be quickly replaced with a replacement filter cartridge without exposing the individual replacing the filter cartridge 12 to foul odors and noxious gasses.

When the filter system 10 is in use, the valve hub 14 and the discharge connector 16 can be installed (connected to) on the gas discharge line 18 once. In turn, the filter cartridge 12 can be easily decoupled and replaced with a replacement filter cartridge without exposing the individual replacing the filter cartridge 12 to foul odors and noxious gasses. The valve hub 14 and the discharge connector 16 can be installed (connected to) on the gas discharge line 18 and can be designed for gas discharge lines having varying diameters (e.g., 16.10 mm lines, 25.75 mm lines, etc.). In many embodiments, the valve hub 14 and the discharge connector 16 are connected to the gas discharge line 18 via a threaded coupling.

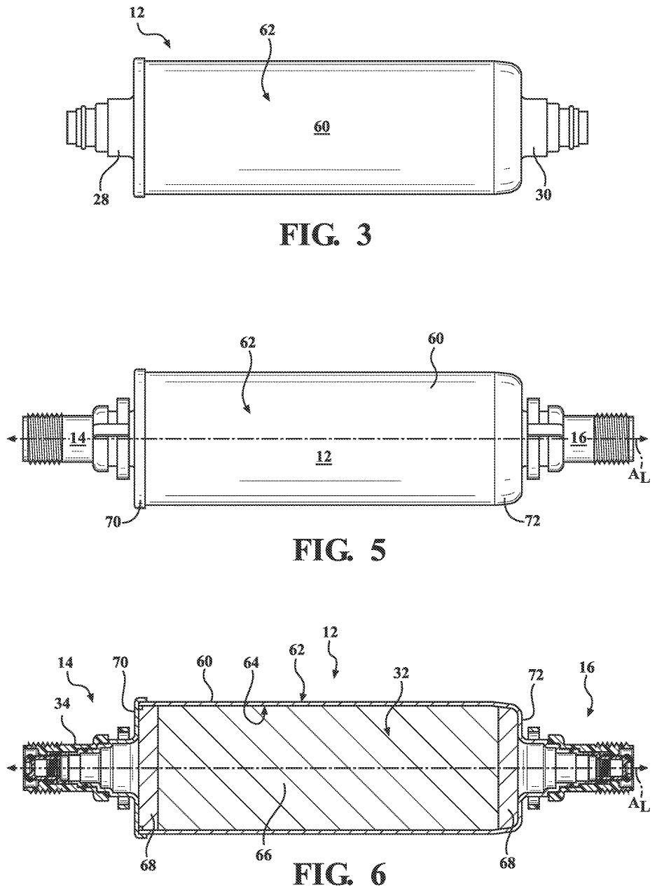

Still referring to FIG. 1, as gas is discharged from the holding tank 20, the gas flows through a first portion 18a of the gas discharge line 18 into the valve hub 14, which connects the first portion 18a of the gas discharge line 18 and the filter cartridge 12. The discharged gas is then cleaned as it flows through the filter cartridge 12. The gas, now innocuous and odor free, flows through the discharge connector 16, which connects the filter cartridge 12 to a second portion 18b of the gas discharge line 18, the second portion 18b of the gas discharge line 18, and out of the vehicle, camper, or marine vessel. An isolated view of the valve hub 14 is illustrated in FIG. 2, an isolated view of the filter cartridge 12 is illustrated in FIG. 3, and an isolated view of the discharge connector 16 is illustrated in FIG. 4.

As is set forth above, the filter system 10 comprises the filter cartridge 12, a valve hub 14, and a discharge connector 16. The filter cartridge has a first end 28 and a second end 30 and defines a chamber 32.

The valve hub 14 has a valve hub body 34 that defines an exterior and an interior surface 36, 38. The interior surface 36 defines an interior cavity 42, which is disposed about a longitudinal axis A_{L}. The valve hub 14 has a first hub end 44 shaped for connection with the first portion 18a of the gas discharge line 18 and a second hub end 46 shaped to releasably couple to the first end 28 of the filter cartridge 12. A valve 48 is movably disposed in the interior cavity 42, the valve 48 is moveable between a closed position when the filter cartridge 12 is uncoupled from valve hub 14 and an open position when the filter cartridge 12 is coupled to the valve hub 14.

The discharge connector 16 has a connector body 50 that defines the exterior connector surface 52 and an interior connector surface 54. The discharge connector has a first connector end 56 shaped to releasably couple to the second end 30 of the filter cartridge 12 and a second connector end 58 shaped for connection with a second portion 18b of the gas discharge line 18.

When the first hub end 44 of the valve hub 14 is connected with a first portion 18a of the gas discharge line 18, the first end 28 of the filter cartridge 12 is releasably coupled to the second hub end 46 of the valve hub 14, the second end 30 of the filter cartridge 12 is releasably coupled with the first connector end 56 of the discharge connector 16, and the second connector end 58 of the discharge connector 16 is connected with the second portion 18b of the gas discharge line 18 the filter system 10 allows for filtering and discharge of gas from the holding tank 20 because the valve 48 of the valve hub 14 is in an open position. When the filter cartridge 12 is uncoupled from the valve hub 14, the valve 48 moves from the open position to the closed position to prevent discharge of unfiltered gas from the holding tank 20 so that the filter cartridge 12 can be replaced without exposing the individual replacing the filter cartridge 12 to foul odors and noxious gasses.

Each of the filter cartridge 12, the valve hub 14, and the discharge connector 16 are described in detail, in turn, below.

Referring now to FIGS. 5-7, the filter cartridge 12 has a first end 28 and a second end 30, and a filter body 60. The filter body 60 defines a chamber 32. More specifically, the filter body 60 defines a filter surface 62 and a chamber surface 64, and the chamber surface 64 defines the chamber 32. The chamber 32 is configured to hold filter media 66 and/or one or more filters 68. In the embodiment illustrated in the cross-sectional view of FIG. 6, the chamber 32 holds a first filter 68a adjacent a first end wall 70 and a second filter 68b adjacent a second end wall 72. In this embodiment, the filter media 66, e.g., activated carbon, is disposed between the first and second filters 68a, 68b.

In many embodiments, the first and the second ends 28, 30 of the filter cartridge are identical and the chamber is configured, as is described below, so that the filter cartridge 12 can be installed either way. To this end, the filter cartridge 12 or replacement filter cartridge 12 can be installed without regard to a specific end and will work the same. To this end, a flow indicator on the filter cartridge is not necessary for these embodiments.

Of course, various embodiments of chamber fill configurations are contemplated including configurations of all filters (e.g., no filter media), of all filter media (e.g., no filters), filters-filter media combinations (including one or more different types of filters and/or one or more different types of filter media). The 68 filter can comprise foam, spun fiberglass materials, pleated paper or cloth, and other materials known in the art. In a preferred embodiment, the first and the second filters 68a, 68b comprise foam and the central part of the cavity is packed with the filter media 66 comprising particulate matter including activated carbon.

In the embodiments illustrated, the first end 28 of the filter cartridge 12 comprises an end probe 74 shaped and positioned to contact a contact surface 76 on the valve 48 and move the valve 48 from the closed position to the open position. The first end 28 of the filter cartridge 12 also comprises a coupling element 78 shaped to engage a locking element 80 on the valve hub 14 to releasably couple the filter cartridge 12 to the valve hub 14. When the filter cartridge 12 is coupled to the valve hub 14 contact between an outer convex surface of the coupling element 78 and an inner concave surface of locking element 80 is maintained, with the locking element 80 preventing the disengagement of the first end 28 of the filter cartridge 12 from the second hub end 46 of the valve hub 14. Further, when the filter cartridge 12 is coupled to the valve hub 14, contact between the end probe 74 on the filter cartridge 12 and the contact surface 76 on the valve 48 is maintained to keep the valve 48 in the open position to allow discharge and filtering of gas from the holding tank 20 when the filter cartridge 12 is coupled to the valve hub 14. It should be appreciated that other types of quick connector are contemplated herein.

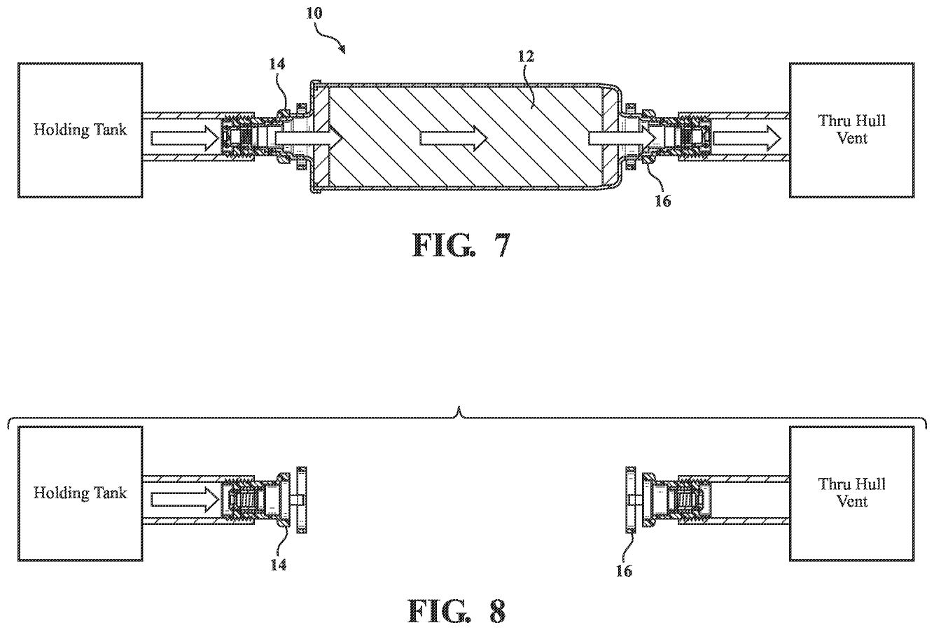

FIG. 5 is a side view of the valve hub 14 coupled to the first end 28 of the filter cartridge 12 and the discharge connector 16 connected to the second end 30 of the filter cartridge 12. Of course, because the filter cartridge 12 is coupled to the valve hub 14, the valve 48 is in the open position to allow discharge and filtering of gas from the holding tank 20. FIG. 6 is a cross-sectional view of FIG. 5 along the longitudinal axis A_{L}, which illustrates the valve 48 in the open position. The arrows of FIG. 7 illustrates the flow of gas within the gas discharge line with the valve in the open position. In contrast, the arrow of FIG. 8 illustrates the flow of gas within the gas discharge line with the filter cartridge 12 decoupled from the valve hub 14, the valve 48 is in the closed position to prevent discharge and filtering of gas from the holding tank 20.

In some embodiments, the first end 28 of the filter cartridge 12 comprises a second alignment feature 84 (e.g., a receiving port) that must be aligned with a first alignment feature 82 (e.g. a tab) on the valve hub 14 to allow insertion of the first end 28 of filter cartridge 12 into the valve hub 14 and subsequent coupling of the filter cartridge 12 to the valve hub 14. If included, the first and second alignment features 82, 84 ensure that the coupling element 78 on first end 28 of the filter cartridge 12 aligns with the locking element 80 on the valve hub 14. In other words, the first and second alignment features 82, 84 align, or set the correct position of, the coupling element 78 and the locking element 80. In some embodiments, a plurality of first and second alignment features 82, 84 are contemplated, e.g., two first alignment features and two, corresponding second alignment features. Further, the configuration of the first and second alignment features can be reversed, e.g., the first alignment feature could be a receiving port and the second alignment feature could be a tab.

In some embodiments, the first end 28 of the filter cartridge 12 comprises a sealing surface 86 including sealing channel 88 and a sealing element 89, e.g., an O-ring. The sealing element 89 helps ensure a pneumatic seal between an interior surface 36 of the valve hub 14 and sealing surface 86 of the filter cartridge so that unfiltered gas does not leak out of the gas discharge line 18 when the filter cartridge 12 is coupled to the valve hub 14. Of course, embodiments wherein the interior surface 36 of the valve hub body 34 at the second hub end 46 of the valve hub 14 includes a sealing channel and sealing element that abuts the sealing surface of the filter cartridge 12 when connected to the valve hub 14 to provide a pneumatic seal are also contemplated. In other words, in other embodiments the seal channel and the sealing element can be incorporated into the valve hub 14, instead of the configuration illustrated or in addition to the configuration illustrated.

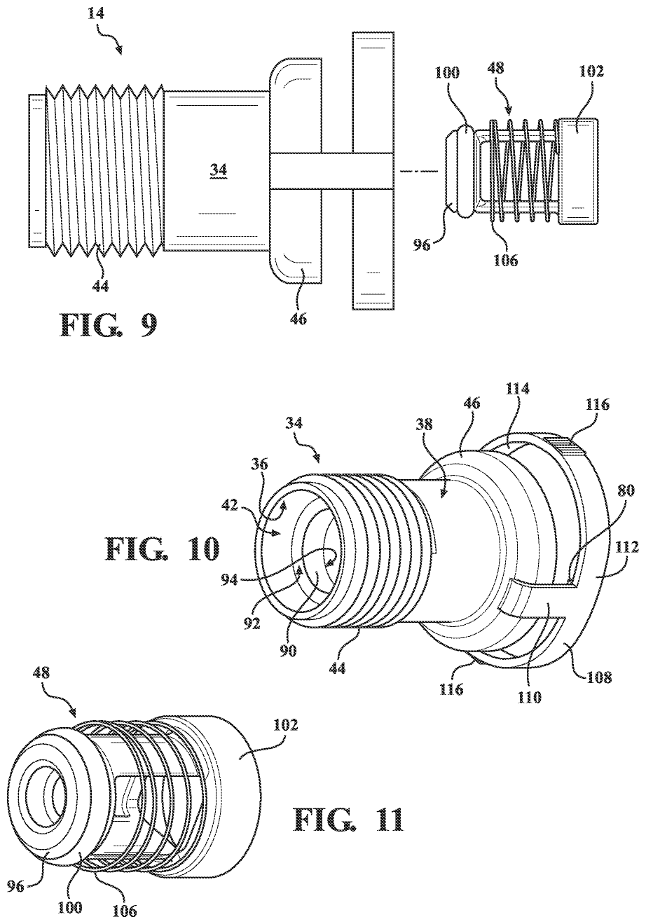

Referring now to FIGS. 9-11, the valve hub 14 has a valve hub body 34 that defines an exterior and an interior surface 38, 36. The interior surface 36 defines an interior cavity 42, which is disposed about a longitudinal axis A_{L}. The valve hub 14 has the first hub end 44 shaped for connection with the first portion 18a of the gas discharge line 18. In the embodiment illustrated, the first hub end 44 is threaded, and an end of the first portion 18a of the gas discharge line 18 defines a threaded receiving port shaped to rotationally receive the threads of the first hub end 44 of the valve hub 14. In other words, end of the first portion 18a of the gas discharge line 18 has a female threaded end and the first hub end 44 is a threaded male end. Of course, the opposite configuration wherein the first hub end 44 of the valve hub 14 has a threaded receiving port shaped to rotationally receive the threads of the end of the first portion 18a of the gas discharge line 18 is also contemplated.

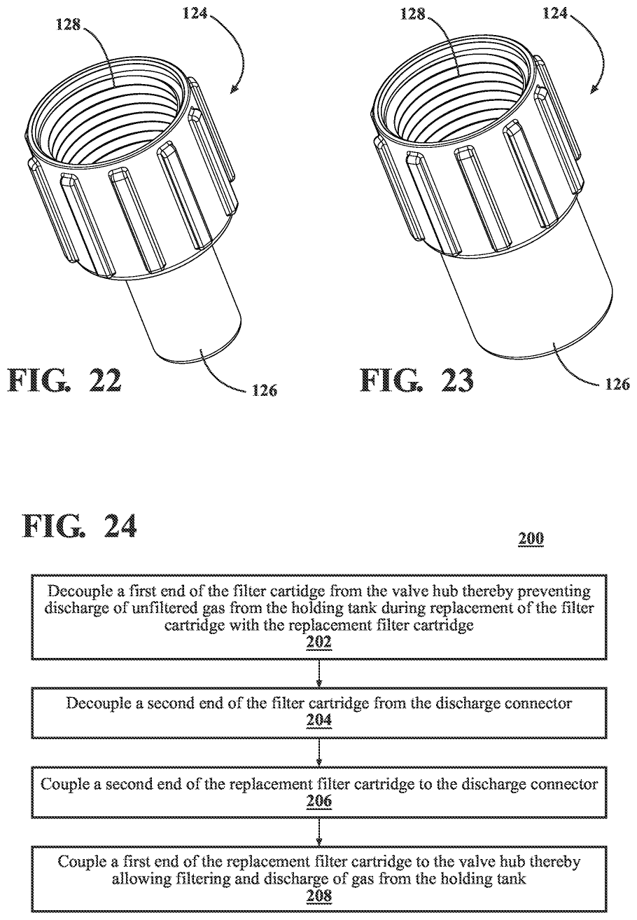

The connection between the first portion 18a of the gas discharge line 18 and the first hub end 44 of the valve hub 14 can be achieved with a variety of connections or quick couplings known in the art. Referring now to FIGS. 22 and 23, in some embodiments, the filter system 10 also includes one or more of a fitting 124 having a first fitting end 126 that can be secured to the gas discharge line 18, e.g., via hose camp that can be tightened with a screw driver, and a second fitting end 128 that has the threaded receiving port shaped to rotationally receive the threads of the first hub end 44 of the valve hub 14 (or shaped to rotationally receive the threads of a second connector end 58 of the discharge connector 16).

The valve 48 is movably disposed in the interior cavity 42 of the valve hub 14. FIG. 9 is an exploded side view of the valve hub 14 including the valve hub body 34 and the valve 48. FIGS. 10 and 11 are isolated perspective views of the valve hub body 34 and the valve 48, respectively.

FIG. 13 is a side view of the valve hub 14 and FIG. 14 is a cross-sectional view of the valve hub 14 of FIG. 13 along the longitudinal axis A_{L}.

As is best illustrated in the cross-sectional view of FIG. 13, in some embodiments, the valve hub body 34 has an interior flange 90 defining a seal surface 92 and a push surface 94. Further, the valve 48 has a head 96 including a valve sealing channel 98 configured to receive a valve sealing element 100 (e.g., an O-ring). In this embodiment, the valve 48 also has a foundation 102 defining a biasing surface 104 and the contact surface 76. In many such embodiments, a biasing element 106 is disposed between the push surface 94 of the interior flange 90 of the valve hub body 34 and the biasing surface 104 of the foundation 102 of the valve 48. In this embodiment, the foundation 102 of the valve 48 is biased away from the push surface 94 of the interior flange 90 along the longitudinal axis A_{L}, which forces the head 96 of the valve 48 into the seal surface 92 to position the valve 48 in the closed position to prevent discharge of unfiltered gas from the holding tank. FIG. 14 is an exploded view of the valve hub 14 including the valve hub body 34, the valve 48, the valve sealing element 100, and the biasing element 106.

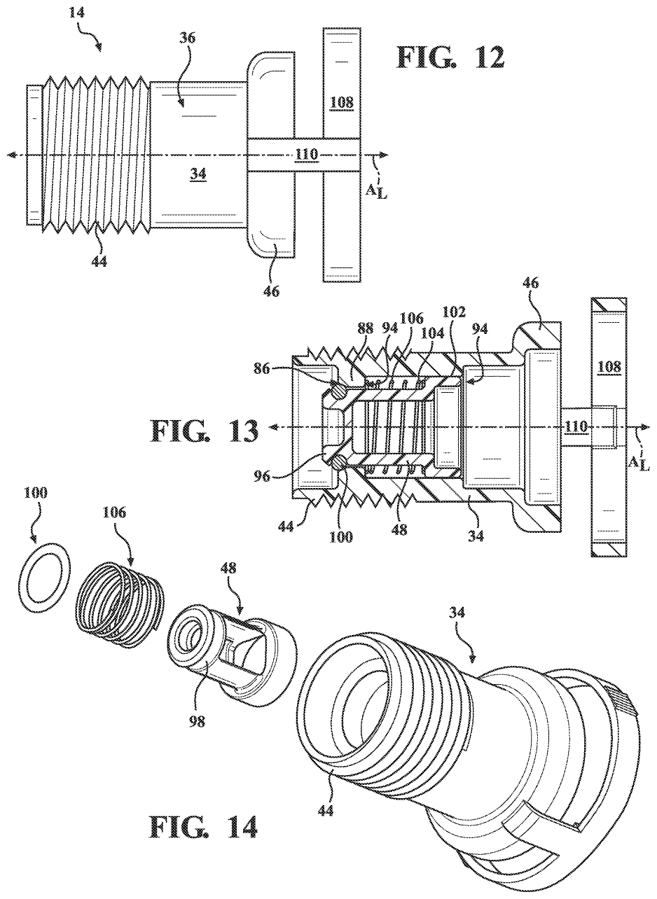

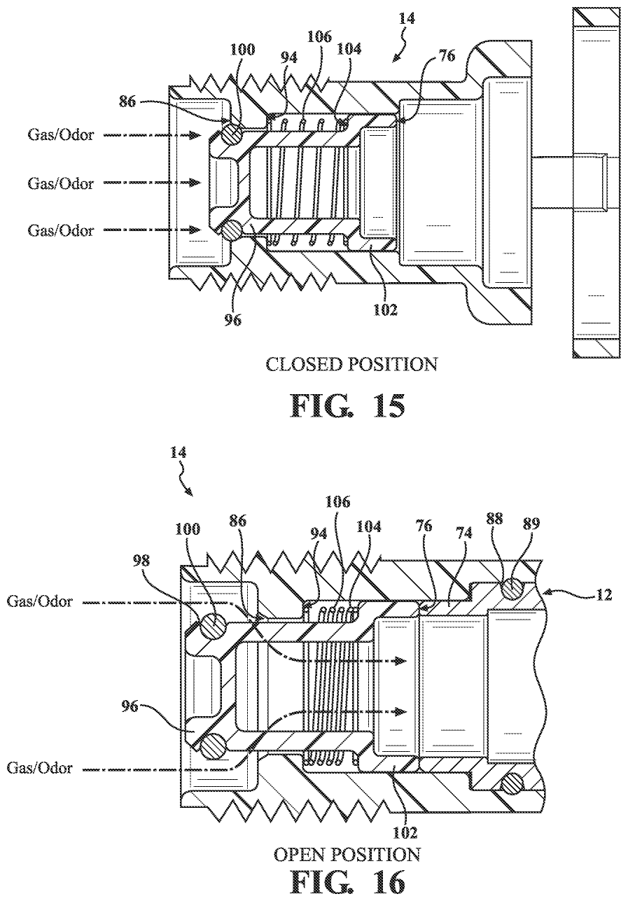

FIG. 15 is a cross-sectional view of the valve hub 14 of FIG. 12 with the valve 48 in the closed position. In FIG. 15, the first end 28 of the filter cartridge 12 is not received in the interior cavity 42 of the valve hub body 34. As such, the biasing element 106, e.g., spring, is in an extended position with the foundation 102 of the valve 48 extended in a distal direction along the longitudinal axis A_{L}. In FIG. 15, the head 96 of the valve 48 including the valve sealing channel 98 with the valve sealing element 100 is pushed into the seal surface 92. As such, the valve 48 is in the closed position and prevents discharge of unfiltered gas from the holding tank.

FIG. 16 is a cross-sectional view of the valve hub 14 of FIG. 12 with the valve 48 in the open position. In FIG. 16, the first end 28 of the filter cartridge 12 is received in the interior cavity 42 of the valve hub body 34. The end probe 74 has contacted the contact surface 76 of the valve 48 and the biasing element, e.g., spring, is in a compressed position with the foundation 102 of the valve 48 extended in a proximal direction along the longitudinal axis A_{L}. In FIG. 16, the head 96 of the valve 48 including the valve sealing channel 98 with the valve sealing element 100 is pushed away from the seal surface 92. As such, the valve 48 is in the open position unfiltered gas can move freely around the head 96, through the valve 48 and into the filter cartridge 12.

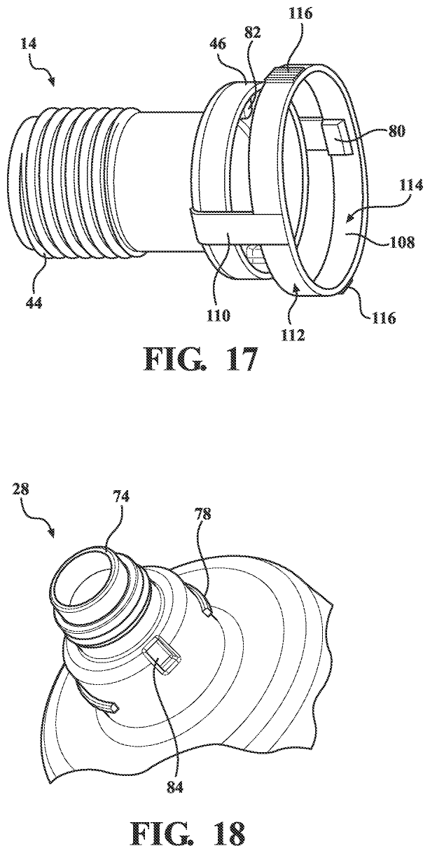

Referring now to FIGS. 17-20, the second hub end 46 is shaped to releasably couple to the first end 28 of the filter cartridge 12. The second hub end 46 of the valve hub 14 comprises a locking element 80 shaped to engage a coupling element 78 on the filter cartridge 12. Referring now to FIG. 18, the second hub end 46 of the valve hub 14 comprises an engagement halo 108 disposed about the longitudinal axis A_{L} and mounted on one or more legs 110. In the embodiment illustrated, the engagement halo 108 is circular in shape mounted on two legs 110. The engagement halo 108 has an exterior halo surface 112 and an interior halo surface 114 including the locking element 80 (in this example, the two locking tabs 80a, 80b, which are adjacent to each of the two legs 110. In the embodiment illustrated, the interior halo surface has two locking elements 80 (e.g., locking tabs) opposite one another, and the exterior halo surface 112 has two pressure pads 116 opposite one another. The two locking elements 80 and the two pressure pads 116 are radially spaced about a perimeter of the engagement halo 108.

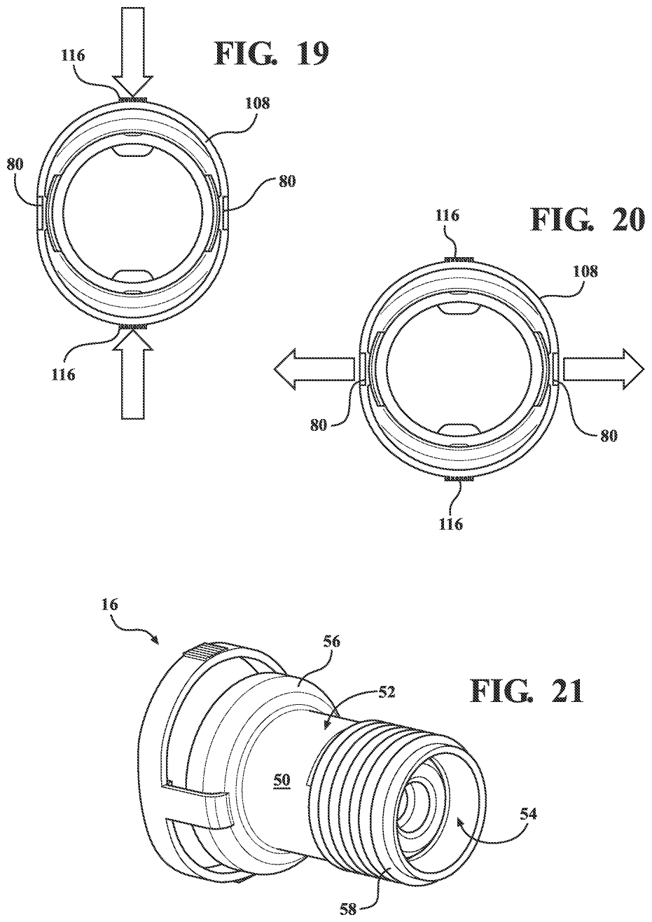

As is illustrated in FIGS. 19 and 20, application of pressure on the two pressure pads 116 elongates the engagement halo 108 thereby forcing the radially spaced opposite sides upon which the two locking elements 80 are located to move apart to allow for insertion of the first end 28 of the filter cartridge 12 into the valve hub 14. Release of pressure on the two pressure pads 116 allows the engagement halo 108, previously elongated, to return to a circular shape thereby moving the two locking elements 80 back together and into engagement with two coupling elements 78 on the filter cartridge 12 to couple the filter cartridge 12 to the valve hub 14 and keep the valve 48 in the open position so that gas discharges from the holding tank 20 flows through the gas discharge line 18 and is filtered and released. During engagement, contact between an outer convex surface of the coupling element 78 and an inner concave surface of locking element 80 is maintained, with the locking element 80 preventing the disengagement of the first end 28 of the filter cartridge 12 from the second hub end 46 of the valve hub 14. Of course, reapplication of pressure on the two pressure pads 116 forces the two locking elements 80 apart and out of engagement with the two coupling elements 78 on the filter cartridge 12 to allow for removal of the first end 28 of the filter cartridge 12 from valve hub 14 and the valve 48 moves to the closed position, to prevent discharge of unfiltered gas from the holding tank 20 so that the filter cartridge 12 can be replaced without exposing the individual replacing the filter cartridge 12 to foul odors and noxious gasses.

Because the engagement halo 108 is flexible an application of pressure on the two pressure pads 116 forces opposite sides the of the engagement halo 108 upon which each of the two pressure pads 116 are located closer together thereby elongating the engagement halo 108 and simultaneously forcing radially spaced opposite sides upon which the two locking elements 80 are located to move apart. When apart, contact between the two locking elements 80 (e.g., locking tabs) do not contact the two corresponding coupling elements/tabs 78 when the filter cartridge 12 is inserted (or withdrawn for that matter) from the interior cavity 42 of the valve hub 14. Once the filter cartridge 12 is inserted into the valve hub 14, release of pressure on the two pressure pads 116 allows the opposite sides the of the engagement halo 108 upon which each of the two pressure pads 116 are located to move apart as the engagement halo 108, previously elongated, returns to a circular shape and simultaneously allows the radially spaced opposite sides upon which the two locking elements 80 are located to move together and engage two corresponding coupling elements 78 (e.g. coupling tabs) on the filter cartridge 12 thereby coupling the filter cartridge 12 to the valve hub 14. The reapplication of pressure on the two pressure pads 116 forces the opposite sides of the engagement halo 108 upon which each of the two pressure pads 116 are located closer together thereby elongating the engagement halo 108 and simultaneously forcing the radially spaced opposite sides upon which the two locking elements 80 are located to move apart and disengage with the two corresponding coupling elements/tabs 78 on the filter cartridge 12 to allow for removal of the first end 28 of the filter cartridge 12 from the valve hub 14.

As set forth above, in some embodiments, the valve hub 14 comprises the first alignment feature 82 and the filter cartridge comprises the second alignment feature 84. Alignment of the first and second alignment features 82, 84 allow insertion of the first end 28 filter cartridge 12 into the interior cavity 42 of the valve hub 14 and ensure that the locking element 80 on the valve hub (two tabs) are aligned with the coupling element 78 (two tabs) on the filter cartridge 12. The first and second alignment features 82, 84 can be designed so that the individual replacing the filter cartridge 12 cannot insert the first end 28 filter cartridge 12 into the interior cavity 42 of the valve hub 14 if the features are not aligned.

Referring now to FIG. 21, the discharge connector 16 has a connector body 50 that defines an exterior connector surface 52 and the interior connector surface 54. The discharge connector 16 has a first connector end 56 shaped to releasably couple to the second end 30 of the filter cartridge 12 and a second connector end 58 shaped for connection with a second portion 18b of the gas discharge line 18. In the embodiment illustrated in FIG. 21, the second connector end 58 is threaded, and a beginning of the second portion 18b of the gas discharge line 18 defines a threaded receiving port shaped to rotationally receive the threads of a second connector end 58 of the discharge connector 16. Of course, the opposite configuration wherein the second connector end 58 of the discharge connector 16 has a threaded receiving port shaped to rotationally receive the threads of the second connector end 58 of the discharge connector 16 is contemplated.

The connection between the second portion 18b of the gas discharge line 18 and the second connector end 58 of the discharge connector 16 can be achieved with a variety of connections or quick couplings known in the art. Referring again to FIGS. 22 and 23, in some embodiments, the filter system 10 also includes another of the fitting 124, having a first fitting end 126 that can be secured to the gas discharge line 18, e.g., via hose camp (not illustrated) that can be tightened with a screw driver, and a second fitting end 128 that has the threaded receiving port shaped to rotationally receive the threads of a second connector end 58 of the discharge connector 16. The filter system 10 can include a specific size of the fitting 124, sized to connect to a particular gas discharge line 18 size on a particular model of boat recreation vehicle, etc. In FIG. 22, the fitting 124 has a first fitting end 126 having an insert with an outer diameter of 16.10 mm and a second fitting end 128 having a threaded receiving port/female threaded end. In FIG. 23, the fitting 124 has a first fitting end 126 having an insert with an outer diameter of 25.75 mm and a second fitting end 128 having a threaded receiving port/female threaded end. Of course, the fittings illustrated in FIGS. 22 and 23 are exemplary in nature and other types and sizes of fittings can be included in the system. In one embodiment, the filter system 10 includes two of the fitting 124, one for connection between the first portion 18a of the gas discharge line 18 and the valve hub 14, and another for connection between the second portion 18b of the gas discharge line 18 and the discharge connector 16.

Referring back to FIG. 21, in the embodiment illustrated, the discharge connector 16 is identical to the valve hub 14 for the sake of simplicity. However, it should be appreciated that discharge connector 16 need not include the valve 48 because it is located downstream on the gas discharge line 18.

A replacement filter cartridge for a filter system for a gas discharge line for a holding tank is also disclosed. The filter system comprises a valve hub, a filter cartridge, and a discharge connector. The valve hub has a locking element and defines a contact surface and an interior cavity with a valve is movably disposed therein. The replacement filter cartridge comprises a filter body defining a filter surface and a chamber surface, the chamber surface defines a chamber for holding a filtration media. The filter body has a first end shaped to releasably couple to the valve hub. The first end includes an end probe shaped and positioned to contact the contact surface of the valve in the valve hub and move the valve from a closed position, which prevents discharge of gas from the holding tank, to an open position, which allows discharge and filtering of gas from the holding tank. The replacement filter cartridge comprises a sealing element for providing a pneumatic seal between an interior surface of the valve hub and an outer surface of the first end. The replacement filter cartridge also comprises at least one coupling element shaped to engage the locking element of the valve hub to releasably couple the replacement filter cartridge to the valve hub and maintain contact between the end probe and the contact surface of the valve to maintain the open position and allow discharge and filtering of gas from the holding tank when the replacement filter cartridge is coupled to the valve hub. The filter body has a second end shaped to releasably couple the filter cartridge to the discharge connector.

A quick coupling for a filter cartridge for a gas discharge line of a holding tank is also disclosed. The filter cartridge has a first and a second end. The quick coupling comprises a valve hub having a valve hub body. The valve hub body has an exterior and an interior surface. The interior surface defines an interior cavity disposed about a longitudinal axis. The valve hub has a first hub end shaped for connection with the gas discharge line. The second hub end comprises a locking element shaped to engage a coupling element on a first end of the filter cartridge. A valve is movably disposed in the interior cavity. The valve is moveable between a closed position when the valve hub is uncoupled from the filter cartridge and an open position when the valve hub is coupled to the filter cartridge. When the first end of the filter cartridge is received in the interior cavity at the second hub end and the filter cartridge is coupled to the valve hub, the valve is in the open position to allow for discharge and filtering of gas from the holding tank. When the filter cartridge is removed from the interior cavity at the second hub end and uncoupled from the valve hub the valve moves to the closed position to prevent discharge of unfiltered gas from the holding tank while the filter cartridge is replaced.

Referring now to FIG. 24, a method 200 of replacing the filter cartridge in the filter system 10 is also disclosed herein. The components of the filter system 10 are just as described above for the method 200 described below. The method comprising the step of decoupling a first end of the filter cartridge from the valve hub thereby preventing discharge of unfiltered gas from the holding tank during replacement of the filter cartridge with the replacement filter cartridge (202). Once the first end of the filter cartridge is decoupled from the valve hub, the second end of the filter cartridge is decoupled from the discharge connector (204). At this juncture, the filter cartridge can be replaced without exposing the individual replacing the filter cartridge to foul odors and noxious gasses. Of course, during the step of decoupling the filter cartridge from the valve hub the valve within the valve hub moves from the open position, which allows the discharge and filtering of gas from the holding tank, to a closed position, which prevents the discharge of unfiltered gas from the holding tank. Once the filter cartridge is completely decoupled (decoupled on both ends), a second end of the replacement filter cartridge is coupled to the discharge connector (206). In turn, the first end of the replacement filter cartridge is coupled to the valve hub thereby allowing discharge and filtering of gas from the holding tank (208).

Statement A: A filter system for a gas discharge line of a holding tank, the filter system comprising:
a filter cartridge having a first end and a second end and defining a chamber;
a valve hub having a valve hub body having an exterior and an interior surface defining an interior cavity disposed about a longitudinal axis, the valve hub having a first hub end shaped for connection with a first portion of the gas discharge line and a second hub end shaped to releasably couple to the first end of the filter cartridge, the valve hub comprising:
a valve movably disposed in the interior cavity, the valve moveable between a closed position when the valve hub is uncoupled from the filter cartridge and an open position when the valve hub is coupled to the filter cartridge; and
a discharge connector having a connector body having an exterior connector surface and an interior connector surface, the discharge connector has a first connector end shaped to releasably couple to the second end of the filter cartridge and a second connector end shaped for connection with a second portion of the gas discharge line;
wherein the first hub end of the valve hub is connected with the first portion of the gas discharge line, the first end of the filter cartridge is releasably coupled to the second hub end of the valve hub, the second end of the filter cartridge is releasably coupled with the first connector end of the discharge connector, and the second connector end of the discharge connector is connected with the second portion of the gas discharge line to allow for filtering and discharge of gas from the holding tank; and
wherein when the filter cartridge is uncoupled from the valve hub the valve moves to the closed position to prevent discharge of unfiltered gas from the holding tank while the filter cartridge is replaced.

Statement B: The filter system of Statement A, wherein:
the valve hub body has an interior flange defining a seal surface and a push surface.

Statement C: The filter system of Statement B, wherein the valve has:
a head including a sealing channel; and
a foundation including a biasing surface and a contact surface.

Statement D: The filter system of Statement C further comprising a biasing element disposed between the push surface of the valve hub body and the biasing surface of the valve, wherein the foundation of the valve is biased away from the interior flange along the longitudinal axis, which forces the head into the seal surface to position the valve in the closed position to prevent discharge of unfiltered gas from the holding tank.

Statement E: The filter system of Statement A, wherein:
the second hub end of the valve hub comprises a locking element shaped to engage a coupling element on the filter cartridge.

Statement F: The filter system of Statement E, wherein:
the valve hub comprises a first alignment feature and the filter cartridge comprises a second alignment feature that can be aligned to allow insertion of the filter cartridge into the valve hub and ensure that the locking element on the valve hub is aligned with the coupling element on the filter cartridge.

Statement G: The filter system of Statement F, wherein:
the second hub end of the valve hub comprises an engagement halo disposed about the longitudinal axis and mounted on one or more legs, the engagement halo having an exterior halo surface and an interior halo surface including the locking element.

Statement H: The filter system of Statement G, wherein:
the interior halo surface has two locking elements opposite one another; and
the exterior halo surface has two pressure pads opposite one another;
wherein the two locking elements and the two pressure pads are radially spaced about a perimeter of the engagement halo.

Statement I: The filter system of Statement H, wherein the engagement halo is:
circular in shape; and/or
mounted on two legs and each of the two locking elements is adjacent to each of the two legs.

Statement J: The filter system of Statement I, wherein:
application of pressure on the two pressure pads elongates the engagement halo thereby forcing radially spaced opposite sides upon which the two locking elements are located to move apart to allow for insertion of the first end of the filter cartridge into the valve hub; and
release of pressure on the two pressure pads allows the engagement halo, previously elongated, to return to a circular shape thereby moving the two locking elements back together and into engagement with two coupling elements on the filter cartridge to couple the filter cartridge to the valve hub.

Statement K: The filter system of Statement J, wherein:
reapplication of pressure on the two pressure pads forces the two locking elements apart and out of engagement with the two coupling elements on the filter cartridge to allow for removal of the first end of the filter cartridge from valve hub.

Statement L: The filter system of Statement A, wherein:
the filter cartridge comprises a filter body having a filter surface and a chamber surface, and the chamber surface defines a chamber for holding filtration media.

Statement M: The filter system of Statement L, wherein:
the first end of the filter cartridge comprises an end probe shaped and positioned to contact the valve in the valve hub and move the valve from the closed position to the open position.

Statement N: The filter system of Statement M, wherein:
the first end of the filter cartridge comprises a coupling element shaped to engage a locking element on the valve hub to releasably couple the filter cartridge to the valve hub and maintain contact between the end probe and the valve to maintain the valve in the open position and allow discharge and filtering of gas from the holding tank when the filter cartridge is coupled to the valve hub.

Statement O: The filter system of Statement N, wherein:
the first end of the filter cartridge comprises a second alignment feature that must be aligned with a first alignment feature on the valve hub to allow insertion of the first end of the filter cartridge into the valve hub and subsequent coupling of the filter cartridge to the valve hub.

Statement P: The filter system of Statement O, wherein:
the first end of the filter cartridge comprises a sealing surface including a sealing element for providing a pneumatic seal between the interior surface of the valve hub.

Statement Q: The filter system of Statement A, wherein:
the holding tank and the gas discharge line are part of a marine vessel or recreational vehicle wastewater system.

Statement R: A method of replacing the filter cartridge in the filter system of statement A with a replacement filter cartridge, the method comprising the steps of:
decoupling a first end of the filter cartridge from the valve hub thereby preventing discharge of unfiltered gas from the holding tank during replacement of the filter cartridge with the replacement filter cartridge;
decoupling a second end of the filter cartridge from the discharge connector;
coupling a second end of the replacement filter cartridge to the discharge connector; and
coupling a first end of the replacement filter cartridge to the valve hub thereby allowing discharge and filtering of gas from the holding tank;
wherein during the step of decoupling the filter cartridge from the valve hub the valve within the valve hub moves from the open position, which allows the discharge and filtering of gas from the holding tank, to a closed position, which prevents the discharge of unfiltered gas from the holding tank.

Statement AA: A replacement filter cartridge for a filter system for a gas discharge line for a holding tank, the filter system comprising a valve hub, a filter cartridge, and a discharge connector, the valve hub defining a contact surface and an interior cavity, the valve hub also having a valve movably disposed in the interior cavity and a locking element, the replacement filter cartridge comprising:
a filter body defining a filter surface and a chamber surface, the chamber surface defining a chamber for holding a filtration media, the filter body having:
a first end shaped to releasably couple to the valve hub, the first end including:
an end probe shaped and positioned to contact the contact surface of the valve in the valve hub and move the valve from a closed position that prevents discharge of gas from the holding tank to an open position that allows discharge and filtering of gas from the holding tank;
a sealing element for providing a pneumatic seal between an interior surface of the valve hub and an outer surface of the first end; and
at least one coupling element shaped to engage the locking element of the valve hub to releasably couple the replacement filter cartridge to the valve hub and maintain contact between the end probe and the contact surface of the valve to maintain the open position and allow discharge and filtering of gas from the holding tank when the replacement filter cartridge is coupled to the valve hub; and
a second end shaped to releasably couple to the discharge connector.

Statement BB: The replacement filter cartridge of statement AA, wherein the first end of the filter cartridge comprises:
a coupling element shaped to engage the locking element of the valve hub to releasably couple the replacement filter cartridge to the valve hub and maintain contact between the end probe and the contact surface of the valve to maintain the open position and allow discharge and filtering of gas from the holding tank when the replacement filter cartridge is coupled to the valve hub.

Statement CC: The replacement filter cartridge of Statement AA, wherein:
the first end of the filter cartridge comprises a second alignment feature that must be aligned with a first alignment feature on the valve hub to allow insertion of the filter cartridge into the valve hub and ensure that the locking element on the valve hub is aligned with the coupling element on the filter cartridge.

Statement DD: The replacement filter cartridge of Statement CC, wherein:
the chamber includes a first filter oriented across the chamber at the first end and a second filter oriented across the chamber at the second end.

Statement EE: The replacement filter cartridge of Statement DD, wherein:
the chamber includes filter media disposed between the first and second filters.

Statement FF: The filter system of Statement EE, wherein:
the filter media comprises activated carbon.

Statement GG: The filter system of Statement AA, wherein:
the first end and the second ends are shaped the same and the chamber includes a combination of filters and/or filter media effective regardless of whether the first end or the second end is attached to the valve hub.

Statement AAA: A quick coupling for a filter cartridge for gas discharge line of a holding tank, the filter cartridge having a first and a second end, the quick coupling comprising:
a valve hub having a valve hub body having an exterior and an interior surface, the interior surface defining an interior cavity disposed about a longitudinal axis, the valve hub having a first hub end shaped for connection with the gas discharge line and a second hub end comprising a locking element shaped to engage a coupling element on the first end of the filter cartridge, the valve hub comprising:
a valve movably disposed in the interior cavity, the valve moveable between a closed position when the filter cartridge is uncoupled from the valve hub and an open position when the filter cartridge is coupled to the valve hub; and
wherein when the first end of the filter cartridge is received in the interior cavity at the second hub end and the filter cartridge is coupled to the valve hub, the valve is in the open position to allow for discharge and filtering of gas from the holding tank; and
wherein when the first end of the filter cartridge is removed from the interior cavity at the second hub end and uncoupled from the valve hub, the valve moves to the closed position to prevent discharge of unfiltered gas from the holding tank while the filter cartridge is replaced.

Statement BBB: The quick coupling of Statement AAA, wherein:
the valve hub body has an interior flange defining a seal surface and a push surface; and
the valve has a head including a sealing channel and a foundation including a biasing surface and a contact surface; and
a biasing element is disposed between the push surface of the valve hub body and the biasing surface of the valve to bias the valve away from the interior flange along the longitudinal axis, which forces the head into the seal surface to position the valve in the closed position to prevent discharge of unfiltered gas from the holding tank.

Statement CCC: The quick coupling of Statement BBB, wherein:
the valve hub comprises a first alignment feature and the filter cartridge comprises a second alignment feature that can be aligned to allow insertion of the filter cartridge into the valve hub and ensure that the locking element on the valve hub is aligned with the coupling element on the filter cartridge.

Statement DDD: The quick coupling of Statement CCC, wherein:
the second hub end of the valve hub comprises an engagement halo disposed about the longitudinal axis and mounted on two legs, the engagement halo having:
two locking elements opposite one another on an interior halo surface; and
two pressure pads opposite one another on an exterior halo surface;
wherein the two locking elements and the two pressure pads are radially spaced about a perimeter of the engagement halo.

Statement EEE: The quick coupling of Statement DDD, wherein the engagement halo is:
circular in shape; and/or
mounted on two legs and each of the two locking elements is adjacent to each of the two legs.

Statement FFF: The quick coupling of Statement EEE, wherein:
the engagement halo is flexible and application of pressure on the two pressure pads forces opposite sides the of the engagement halo upon which each of the two pressure pads are located closer together thereby elongating the engagement halo and simultaneously forcing radially spaced opposite sides upon which the two locking elements are located to move apart,
movement of the locking tabs prevents contact between the two locking elements and two corresponding coupling elements on the filter cartridge to allow for insertion of the first end of the filter cartridge into the valve hub; and
once the filter cartridge is inserted into the valve hub, release of pressure on the two pressure pads allows the opposite sides the of the engagement halo upon which each of the two pressure pads move apart as the engagement halo, previously elongated, returns to a circular shape and simultaneously allows radially spaced opposite sides upon which the two locking elements are located to move together and engage two corresponding coupling elements on the filter cartridge thereby coupling the filter cartridge to the valve hub, and
reapplication of pressure on the two pressure pads forces the opposite sides the of the engagement halo upon which each of the two pressure pads are located closer together thereby elongating the engagement halo and simultaneously forcing the radially spaced opposite sides upon which the two locking elements are located to move apart and disengage with the two corresponding coupling elements on the filter cartridge to allow for removal of the first end of the filter cartridge from the valve hub.

Statement AAAA: A method of replacing a filter cartridge in a filter system for a gas discharge line of a holding tank with a replacement filter cartridge, the filter system comprising the filter cartridge, a valve hub, and a discharge connector, the method comprising the steps of:
decoupling a first end of the filter cartridge from the valve hub thereby preventing discharge of unfiltered gas from the holding tank during replacement of the filter cartridge with the replacement filter cartridge;
decoupling a second end of the filter cartridge from the discharge connector;
coupling a second end of the replacement filter cartridge to the discharge connector; and
coupling a first end of the replacement filter cartridge to the valve hub thereby allowing filtering and discharge of gas from the holding tank;
wherein during the step of decoupling the filter cartridge from the valve hub a valve within the valve hub moves from an open position that allows the discharge and filtering of gas from the holding tank to a closed position that prevents the discharge of gas from the holding tank, and during the step of coupling the replacement filter cartridge to the valve hub the valve within the valve hub moves from the closed position that prevents the discharge of gas from the holding tank to the open position that allows discharge and filtering of gas from the holding tank.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements by ordinal terms, for example “first,” “second,” and “third,” are used for clarity, and are not to be construed as limiting the order in which the claim elements appear. Any reference to claim elements in the singular, for example, using the articles “a,” “an,” “the” or “said,” is not to be construed as limiting the element to the singular.

1. A filter system for a gas discharge line of a holding tank, the filter system comprising:
a filter cartridge having a first end and a second end and defining a chamber;
a valve hub having a valve hub body having an exterior and an interior surface defining an interior cavity disposed about a longitudinal axis, the valve hub having a first hub end shaped for connection with a first portion of the gas discharge line and a second hub end shaped to releasably couple to the first end of the filter cartridge, the valve hub comprising:
a valve movably disposed in the interior cavity, the valve moveable between a closed position when the valve hub is uncoupled from the filter cartridge and an open position when the valve hub is coupled to the filter cartridge; and
a discharge connector having a connector body having an exterior connector surface and an interior connector surface, the discharge connector having a first connector end shaped to releasably couple to the second end of the filter cartridge and a second connector end shaped for connection with a second portion of the gas discharge line;
wherein the first hub end of the valve hub is connected with the first portion of the gas discharge line, the first end of the filter cartridge is releasably coupled to the second hub end of the valve hub, the second end of the filter cartridge is releasably coupled with the first connector end of the discharge connector, and the second connector end of the discharge connector is connected with the second portion of the gas discharge line to allow for filtering and discharge of gas from the holding tank; and
wherein when the filter cartridge is uncoupled from the valve hub, the valve moves to the closed position to prevent discharge of unfiltered gas from the holding tank while the filter cartridge is replaced.

2. The filter system of claim 1, wherein:
the valve hub body has an interior flange defining a seal surface and a push surface;
the valve has a head including a sealing channel and a foundation including a biasing surface and a contact surface; and
a biasing element is disposed between the push surface of the valve hub body and the biasing surface of the valve to bias the valve away from the interior flange along the longitudinal axis, which forces the head into the seal surface to position the valve in the closed position to prevent discharge of unfiltered gas from the holding tank when the filter cartridge is not coupled to the valve hub.

3. The filter system of claim 1, wherein:
the second hub end of the valve hub comprises a locking element and the first end of the filter cartridge comprises a coupling element, the locking element configured to engage the coupling element on the filter cartridge to couple the filter cartridge to the valve hub and maintain the valve in the open position and allow discharge and filtering of gas from the holding tank when the filter cartridge is coupled to the valve hub.

4. The filter system of claim 3, wherein:
the valve hub comprises a first alignment feature and the filter cartridge comprises a second alignment feature that can be aligned to allow insertion of the filter cartridge into the valve hub and ensure that the locking element on the valve hub is aligned with the coupling element on the filter cartridge.

5. The filter system of claim 3, wherein:
the second hub end of the valve hub comprises an engagement halo disposed about the longitudinal axis and mounted on one or more legs, the engagement halo having an exterior halo surface and an interior halo surface including the locking element.

6. The filter system of claim 5, wherein:
the interior halo surface has two locking tabs opposite one another; and
the exterior halo surface has two pressure pads opposite one another;
wherein the two locking tabs and the two pressure pads are radially spaced about a perimeter of the engagement halo.

7. The filter system of claim 6, wherein:
application of pressure on the two pressure pads elongates the engagement halo thereby forcing radially spaced opposite sides upon which the two locking tabs are located to move apart to allow for insertion of the first end of the filter cartridge into the valve hub; and
release of pressure on the two pressure pads allows the engagement halo, previously elongated, to return to a circular shape thereby moving the two locking tabs back together and into engagement with two coupling elements on the filter cartridge to couple the filter cartridge to the valve hub.

8. The filter system of claim 7, wherein:
reapplication of pressure on the two pressure pads forces the two locking tabs apart and out of engagement with the two coupling elements on the filter cartridge to allow for removal of the first end of the filter cartridge from the valve hub.

9. The filter system of claim 1, wherein:
the filter cartridge comprises a filter body having a filter surface and a chamber surface, and the chamber surface defines a chamber for holding filtration media.

10. The filter system of claim 9, wherein:
the first end of the filter cartridge comprises an end probe shaped and positioned to contact the valve in the valve hub and move the valve from the closed position to the open position.

11. The filter system of claim 1, wherein:
the holding tank and the gas discharge line are part of a marine vessel or recreational vehicle wastewater system.

12. A method of replacing the filter cartridge in the filter system of claim 1 with a replacement filter cartridge, the method comprising the steps of:
decoupling a first end of the filter cartridge from the valve hub thereby preventing discharge of unfiltered gas from the holding tank during replacement of the filter cartridge with the replacement filter cartridge;
decoupling a second end of the filter cartridge from the discharge connector;
coupling a second end of the replacement filter cartridge to the discharge connector; and
coupling a first end of the replacement filter cartridge to the valve hub thereby allowing discharge and filtering of gas from the holding tank;
wherein during the step of decoupling the filter cartridge from the valve hub, the valve within the valve hub moves from the open position, which allows the discharge and filtering of gas from the holding tank, to a closed position, which prevents the discharge of unfiltered gas from the holding tank.

13. A replacement filter cartridge for a filter system for a gas discharge line for a holding tank, the filter system comprising a valve hub, a filter cartridge, and a discharge connector, the valve hub defining a contact surface and an interior cavity, the valve hub also having a valve movably disposed in the interior cavity and a locking element, the replacement filter cartridge comprising:
a filter body defining a filter surface and a chamber surface, the chamber surface defining a chamber for holding a filtration media, the filter body having:
a first end shaped to releasably couple to the valve hub, the first end including:
an end probe shaped and positioned to contact the contact surface of the valve in the valve hub and move the valve from a closed position that prevents discharge of gas from the holding tank to an open position that that allows discharge and filtering of gas from the holding tank;
a sealing element for providing a pneumatic seal between an interior surface of the valve hub and an outer surface of the first end; and
at least one coupling element shaped to engage the locking element of the valve hub to releasably couple the replacement filter cartridge to the valve hub and maintain contact between the end probe and the contact surface of the valve to maintain the open position and allow discharge and filtering of gas from the holding tank when the replacement filter cartridge is coupled to the valve hub; and
a second end shaped to releasably couple to the discharge connector.

14. The replacement filter cartridge of claim 13, wherein:
the first end of the filter cartridge comprises a second alignment feature that must be aligned with a first alignment feature on the valve hub to allow insertion of the filter cartridge into the valve hub and ensure that the locking element on the valve hub is aligned with the at least one coupling element on the filter cartridge.

15. The replacement filter cartridge of claim 14, wherein:
the chamber includes a first filter oriented across the chamber at the first end and a second filter oriented across the chamber at the second end; and
the chamber includes filter media comprising activated carbon disposed between the first and second filters.

16. The filter system of claim 15, wherein:
the first end and the second end are shaped the same and the chamber includes a combination of filters and/or filter media effective regardless of whether the first end or the second end is attached to the valve hub.

17. A quick coupling for a filter cartridge for a gas discharge line of a holding tank, the filter cartridge having a first end and a second end, the quick coupling comprising:
a valve hub having a valve hub body having an exterior and an interior surface, the interior surface defining an interior cavity disposed about a longitudinal axis, the valve hub having a first hub end shaped for connection with the gas discharge line and a second hub end comprising a locking element shaped to engage a coupling element on the first end of the filter cartridge, the valve hub comprising:
a valve movably disposed in the interior cavity, the valve moveable between a closed position when the filter cartridge is uncoupled from the valve hub and an open position when the filter cartridge is coupled to the valve hub; and
wherein when the first end of the filter cartridge is received in the interior cavity at the second hub end and the filter cartridge is coupled to the valve hub, the valve is in the open position to allow for discharge and filtering of gas from the holding tank; and
wherein when the first end of the filter cartridge is removed from the interior cavity at the second hub end and uncoupled from the valve hub, the valve moves to the closed position to prevent discharge of unfiltered gas from the holding tank while the filter cartridge is replaced.

18. The quick coupling of claim 17, wherein:
the valve hub comprises a first alignment feature and the filter cartridge comprises a second alignment feature that can be aligned to allow insertion of the filter cartridge into the valve hub and ensure that the locking element on the valve hub is aligned with the coupling element on the filter cartridge.

19. The quick coupling of claim 18, wherein:
the second hub end of the valve hub comprises an engagement halo disposed about the longitudinal axis and mounted on two legs, the engagement halo having:
two locking tabs opposite one another on an interior halo surface; and
two pressure pads opposite one another on an exterior halo surface;
wherein the two locking tabs and the two pressure pads are radially spaced about a perimeter of the engagement halo.

20. The quick coupling of claim 19, wherein:
the engagement halo is flexible and application of pressure on the two pressure pads forces opposite sides of the engagement halo upon which each of the two pressure pads are located closer together thereby elongating the engagement halo and simultaneously forcing radially spaced opposite sides upon which the two locking tabs are located to move apart,
movement of the locking tabs prevents contact between the two locking tabs and two corresponding coupling elements on the filter cartridge to allow for insertion of the first end of the filter cartridge into the valve hub; and
once the filter cartridge is inserted into the valve hub, release of pressure on the two pressure pads allows the opposite sides the of the engagement halo upon which each of the two pressure pads are located to move apart as the engagement halo, previously elongated, returns to a circular shape and simultaneously allows radially spaced opposite sides upon which the two locking tabs are located to move together and engage two corresponding coupling elements on the filter cartridge thereby coupling the filter cartridge to the valve hub, and
reapplication of pressure on the two pressure pads forces the opposite sides the of the engagement halo upon which each of the two pressure pads are located closer together thereby elongating the engagement halo and simultaneously forcing the radially spaced opposite sides upon which the two locking tabs are located to move apart and disengage with the two corresponding coupling elements on the filter cartridge to allow for removal of the first end of the filter cartridge from the valve hub.
